(19) United States
(12) Patent Application Publication
(10) Pub. No.: US 2010/0322831 A1
(43) Pub. Date: Dec. 23, 2010

(54) METHOD FOR THE PRODUCTION OF METAL PRODUCTS

(75) Inventor: Asher Vitner, Jerusalem (IL)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignees: Joma International AS, Limingen (NO); Asher Vitner Ltd., Jerusalem (IL)

(21) Appl. No.: 12/598,595

(22) PCT Filed: May 1, 2008
(86) PCT No.: PCT/IL08/00583

§ 371 Date: Aug. 16, 2010

(30) Foreign Application Priority Data
May 3, 2007 (IL) 182946

(51) Int. Cl. C22B 34/12; C21B 15/00

(52) U.S. Cl. 423/81; 423/145

(57) ABSTRACT

The invention provides a method for the Industrial purification of a low-grade polyvalent cation feed stream of purity P1, by the formation of a polyvalent cation-double-salt precipitate of purity P2 and a polyvalent cation solution with purity P3, wherein P2>P1>P3, said method comprising the steps of: a) forming, from said feed, a medium comprising water, polyvalent cation, a cation selected from the group consisting of ammonium, cations of alkali metals, protons and a combination thereof, and anions; which formed medium is further characterized by the presence of (i) a double-salt precipitate comprising a polyvalent cation, at least one of said cations and at least one of said anions; and (ii) a polyvalent cation solution; and wherein the concentration of said anions is higher then 10% and the ratio between the concentrations of said cation to said anion in said polyvalent cation solution is within Zone DS as herein defined; and b) separating at least a portion of said precipitate from said solution.

The present invention relates to a method for the production of metal products. More particularly the present invention relates to a method for the production of metal products from a stream solution of mixed metal salts.

The industrial production of polyvalent metal cations products, from ores usually includes a leaching stage, followed by expensive purification stages. In some cases, as in the case of Ti(IV), the leaching step might include attack by a reagent (Cl₂) to free it from oxygen.

The ore from which the metals are leached, usually contain a mixture of monovalent and polyvalent cations, since in most cases metal oxides or insoluble salts of the polyvalent cations yield a solution containing a mixture of cations.

The separation between the various cations and the process of the purification of the product are major cost contributors to the production cost of the various metal products whether it be the salt or the metal itself.

The process of the present invention is directed to a method for the purification of polyvalent cation products from an impure polyvalent cation stream using a purification stage in which the double salt of the metal cation is produced.

A double salt is defined as a crystal that consists of two different cations and/or anions, wherein it is characterized by a significant lower solubility compared to the simple salts of its components. Double salts can be produced from a large number of polyvalent cations (which will be referred to as “polyvalent cation”) such as Fe(II), Fe(III), Ti(IV) Ti(III), Mn(II) and many others. The second cation present in the double salt is in most cases a mono-valent cation but might also be a divalent cation, (which will be referred to in the following as “cation” or monovalent cation) such as ammonium, Na, K, Cs etc.

Heretofore, there has practically been no industrial use of the action of crystallization of a double salt for the production of any metal product (salt or metal—In the following, the term salts will includes also oxides and hydroxides). The main reason for that is the fact that many cations form double salts and those salts co-precipitate to form a product with low purity.

Patent BR 20012509 authored by SILVA HELIO JOSE in 2003 separates titanium oxide from other polyvalent cations present in Ilmenite or other titanium containing ores. In this proposed process, Fe and Al are separated from the titanium salt prior to the precipitation of Fe(III) in the form of ammonium double salt. The addition of ammonium sulfate to a solution obtained by leaching Ilmenite with sulfuric acid, induced the precipitation of the binary salts (NH₄)Fe(SO₄)₂12H₂O, (NH₄)₂TiO(SO₄)₂H₂O, and (NH₄)₂Fe(SO₄)₂6H₂O together.

According to the present invention, it was surprisingly found that above a certain anion concentration level and at a certain range of total cations to total anion ratio, there is, in most cases, high selectivity in the precipitation of the polyvalent I cations present in solution.

In the case in which the anion is SO₄ (or HSO₄) it was found that at total added concentration of SO₄ of above 10%, the solubility of the double salts of the various cations is very high at most cation to SO₄ ratios. At a certain range of cation/SO₄ ratio, it was found that the solubility of the metal cation double salts falls drastically and it can be precipitated from the solutions at a very high yield. It was also very surprisingly found that the cation/SO₄ range, in which the solubility of the double salt is low, differs for each polyvalent metal cation relative to other polyvalent metal cations and for each polyvalent cation the reduction in solubility happens at another SO₄ concentration.

In some case, such as in the case of Fe(II) and Fe(III), the reduction of the solubility of the double salt is very significant for Fe(II), while for Fe(III) the reduction in solubility is much more moderate. The result is that high selectivity is found for the separation of the double salt of Fe(II) from that of Fe(III) in the mixed solution. The high variability in the zone of “double salt low solubility” between various polyvalent cations can be used, for example, for the separation between Ti(IV) and Fe(II) and Fe(III) present in Ilmenite leachate, or between Cu to Fe cations present in various Cu ores.

It was very surprisingly found that by controlling the pH and the concentration of the anion, the various polyvalent cations can be precipitated one after the other to form the double salts of those polyvalent cations at high purity.

It was also surprisingly found that the produced double salt can be washed with very low losses of the specific metal cation, to provide a product of a grade sufficient for the production of metallic product, raw material for metallic product and other metal products (salts, oxides or hydroxides) of high purity.

### DISCLOSURE OF THE INVENTION

With this state of the art in mind, there is now provided, according to the present invention, a method for the Industrial purification of a low-grade polyvalent cation feed stream of purity P1, by the formation of a polyvalent cation-double-salt precipitate of purity P2 and a polyvalent cation solution with purity P3, wherein P2>P1>P3, said method comprising the steps of:
a) forming, from said feed, a medium comprising water, polyvalent cation, a cation selected from the group consisting of ammonium, cations of alkali metals, protons and a combination thereof, and anions; which formed medium is further characterized by the presence of (i) a double-salt precipitate comprising a polyvalent cation, at least one of said cations and at least one of said anions; and (ii) a polyvalent cation solution; and wherein the concentration of said anions is higher then 10% and the ratio between the concentrations of said cation to said anion in said polyvalent cation solution is within Zone DS as herein defined; and
b) separating at least a portion of said precipitate from said solution.

The method also includes the purification of a mixed polyvalent cation mixed-stream, by precipitation of double salts, purification of the resulting double salt by washing with a salt solution, and/or re-crystallization of the double salt.

The purified polyvalent cation double salt can be used for the production of the metal of the polyvalent cation or the oxide/hydroxide of the polyvalent cation and other polyvalent cation products.

According to a preferred embodiment, the anion is SO₄ (or HSO₄) and the cation is ammonium.

The term “metal-double-salt” as used in the present specification refers to a crystal that consists of an anion, a cation (mono or divalent) and polyvalent cations

The term “purity” or “P” will be defined as the weight ratio between the purified polyvalent cation to total polyvalent metal cations, wherein the purity is presented in several cases in terms of percentage, for example P1 as used in the present specification refers to the purity of the polyvalent cation in the low-grade polyvalent cation feed stream.

Purity=Polyvalent cation/Sum(Polyvalent cations);

wherein Polyvalent cation is the concentration of the purified polyvalent cation; and

Sum(Polyvalent cations)=sum of the concentration of the various polyvalent cations

The term “metal” used in the present specification especially in Step (c), will refer to metal at zero valency.

The term “polyvalent metal cation” used in the present specification will refer to any polyvalent metal cation product.

The term “Zone DS” is defined as the zone in which the solubility of the double salt of the polyvalent cation is low (lower than the solubility outside the range included in that Zone).

Zone DS can be defined in two ways:
1. the zone between the values X and Y wherein:
   Y represents the higher pH limit that is the higher cation/anion (eq/eq value) and X represents the lower pH limit that is the lower cation/anion (eq/eq value); and wherein the terms “cations” in the above definition include all cations present in solution but not protons;
2. the zone between the two pH values between which the double salt has its minimal solubility (the pH of the solutions having the X or Y values).

### Zone DS of the Various Polyvalent Cations:

TABLE 1
Zone DS limits (according to method 1 (by X and Y))

| | X | Y |
|---|---|---|
| Mi | Eq/Eq | Eq/Eq |
| Ti (iii) | 0.8 | 1.65 |
| Ti (iv) | 0.3 | 1.4 |
| Fe(ii) | 0.5 | 4 |
| Fe (iii) | 0.5 | 3 |
| Manganese | 0.6 | 1.2 |
| Zinc | 0.25 | 1.75 |
| Cobalt | 0.47 | 1.8 |
| Cr | 0.3 | 1.4 |
| Al (iii) | 0.5 | 1.2 |
| Cu (ii) | 0.3 | 1.0 |
| Tin | 0.8 | 2.5 |
| Nickel | 0.7 | 1.9 |
| Vanadium | 0.4 | 2.4 |
| Cadmium | 0.2 | 2.2 |

Eq = equivalent (= molarity divided by the valency of the ion)

The present disclosure suggests a highly efficient process for the purification of low-grade polyvalent cations streams and enables the fractionation of the various polyvalent cations from each other.

In a preferred embodiment of the present invention, said precipitated double salt is further purified by washing it with aqueous solution, most preferable a solution containing the same anion and cation present in said medium, and at a similar pH level or by re-crystallization of the double salt that is most preferably done within Zone DS.

In a preferred embodiment of the present invention, said precipitated purified double salt is further processed to produce the polyvalent metal oxide. In another preferred embodiment, said precipitated double salt is further processed to produce the polyvalent cation products other than metal oxide, such as salts or complexes.

In another preferred embodiment of the present invention, said precipitated purified double salt is further processed to produce the metal of the polyvalent cation.

The precipitation of the polyvalent cation double salt is most preferably done by contacting said polyvalent cation low grade feed with at least one of an acid, a base and a salt. By keeping the anion concentration above 10% and the ratio between the cations to that of anions within Zone DS, the solubility of the double salt of the polyvalent cation is reduced, thus leading to its precipitation. In order to obtain high selectivity between the various polyvalent cations present in solution, it is highly preferred to keep the cation/anion ratio within Zone DS of the precipitated polyvalent cation, while at that cation/anion ratio, the other polyvalent cations of interest are outside Zone DS for those polyvalent cations. Even a relatively small difference in the range of Zone DS for the various polycations present in solution enables high selectivity in the precipitation of the selected cation.

After the removal of the precipitated double salt, one may change the cation/anion ratio (and their concentrations) so that another polyvalent cation is within its Zone DS thus leading to its precipitation as a relatively pure product. In such a way, the various polyvalent cations present in solution can be precipitated one after the other to obtain the various polyvalent cations, as their various double salts at high purity.

The selectivity between the various polyvalent cations can be very much increased by modifying the composition of the polyvalent cation solution including the concentration of the anions and the cation to anion ratio.

An additional tool that can be used is changing temperature. Thus for example, the first precipitated double salt might be precipitated at one temperature level (in which the solubility of another polyvalent cation present in solution is high). In the second stage, the cation to anion ratio is modified to outside Zone DS of the first cation and the temperature is modified thus precipitating the second polyvalent cation double salt.

In a preferred order of precipitation, the polyvalent cations present at high concentration are precipitated before those with much lower concentration in solution.

In the most preferred embodiment, the polyvalent cation feed contains one or more of the following polyvalent cations: Ti(iv), Ti(iii), Fe(ii), Fe(III), the cations of Mn, Zn, Co, Cr, Al, Cd, Tin, Ni, V or Cd. However, other polyvalent cations may also be included and purified using the suggested method.

In a preferred embodiment said polyvalent cation low grade feed is formed by leaching ores of said polyvalent metals using an acid solution (acidic leaching) or in another preferred embodiment said polyvalent cation low grade feed is formed by leaching ores of said polyvalent metals using a basic solution (basic leaching). In another embodiment, the polyvalent cation feed stream comprises a waste stream from an industrial process.

In a preferred embodiment, the purity of the polyvalent feed solution—P1 is in the range of between about 10% and about 90%.

In another preferred embodiment, P1 is less than 70% and P2 is greater than 95%, and in another preferred embodiment P1 is less than 90% and P2 is greater than 98%.

The present invention can be used to increase the purity of a polyvalent cation containing product, from a very low level to a very high level that can reach higher than 99.9%, by crystallizing the polyvalent cation double salt within zone DS, washing it and re-crystallizing the double salt. In the most preferred embodiment, the wash and the re-crystallization steps (one or more) are performed within Zone DS.

In a preferred embodiment, the molar ratio between said polyvalent cation and other polyvalent cations in said double salt is greater than the ratio in said polyvalent cation feed stream by a factor of at least 5.

Various monovalent and divalent cations can form double salts with polyvalent cations. Many of them have low solubility within Zone DS of the polyvalent cation. In a preferred embodiment of the present invention, said cation in said double-salt is ammonium. In another preferred embodiment said cation in is selected from the group consisting of monoalkyl ammonium, dialkyl ammonium, trialkyl ammonium or tetraalkyl ammonium. In another preferred embodiment the cation in said double-salt is selected from the group consisting of sodium and potassium.

Various anions can form double salts with polyvalent cations. Many of them have low solubility within Zone DS of the polyvalent cation. In the preferred embodiment of the present invention, said anion in said double-salt is selected from the group consisting OH, SO₄ HSO₄ and halides. In another preferred embodiment the anion is selected from a group consisting organic acids such as oxalates.

The present invention enables the precipitation of the polyvalent cation at a high yield and purity. In a preferred embodiment of the present invention, the precipitate contains at least 80% of the polyvalent cation originally present in said low-grade-stream solution. In another preferred embodiment, the P2/P3 ratio is greater than 2 and in a more preferred embodiment the P2/P3 ratio is greater than 10.

In a preferred embodiment, said polyvalent cation solution is modified to form products selected from the group consisting of products containing other polyvalent cations present in said titanium feed solution, wherein one of the modification stages is crystallization. In a preferred embodiment the products of the other polyvalent cations are selected from the group of double salts

A preferred embodiment of the present method further comprises the step of re-crystallizing said precipitate, optionally pre-washed, to form a precipitate with a purity of P6 and a mother liquor with a purity P7, wherein P6>P2>P7.

Preferably, said re-crystallization uses a solution comprising at least one cation and at least one anion selected from said groups as defined above.

In preferred embodiments said double salt is an iron double salt and the anion of said double iron salt is selected from the group consisting of monovalent anions, divalent anions, halide anions, sulfate and bisulfate anions, organic acids anions and a combination thereof.

Preferably the purity of said polyvalent cation-double-salt (P2) is greater than 80%.

In preferred embodiments said cation double salt (P2) is a titanium double salt wherein the purity of said titanium-double-salt (P2) is greater than 99%.

Preferably said polyvalent cation feed is a mother liquor from the precipitation of a double salt.

In some preferred embodiments the anion is SO₄ at a concentration higher then 20%.

In other preferred embodiments the polyvalent cation is Zn(II) and the anion is SO₄ at a concentration higher then 28%.

Preferably said polyvalent cation product contains at least 70% of said polyvalent cation that was presented in said low-grade-stream solution.

In preferred embodiments the pH of said medium is lower then 5. In some preferred embodiments the polyvalent cation is Ti(iv) and Zone DS limits are between 0.3 to 1.4.

In other preferred embodiments the polyvalent cation is Ti(ii) and Zone DS limits are between 0.5 to 1.5

In said other preferred embodiments, preferably, the polyvalent cation is Ti(ii) and Zone DS limits are between 1.5 to 3.5.

In some preferred embodiments the polyvalent cation is Cu(ii) and Zone DS limits are between 0.3 to 1.0.

In other preferred embodiments the polyvalent cation is Fe(ii) and Zone DS limits are between 0.7 to 4.

In yet other preferred embodiments the polyvalent cation is Fe(iii) and Zone DS limits are between 0.8 to 3.

In still other preferred embodiments the polyvalent cation is Zn(ii) and Zone DS limits are between 0.25 to 1.75.

In some preferred embodiments the polyvalent cation is manganese and Zone DS limits are between 0.6 to 1.2.

In other preferred embodiments the polyvalent cation is cobalt and Zone DS limits are between 0.47 to 1.8.

In yet other preferred embodiments the polyvalent cation is Chromium (Cr) and Zone DS limits are between 0.3 to 1.4.

In some preferred embodiments the polyvalent cation is Al(ii) and Zone DS limits are between 0.5 to 1.2.

In other preferred embodiments the polyvalent cation is Tin and Zone DS limits are between 0.8 to 2.5.

In yet other preferred embodiments the polyvalent cation is Nickel and Zone DS limits are between 0.7 to 1.9.

In some preferred embodiments the polyvalent cation is Vanadium and Zone DS limits are between 0.4 to 2.4.

In other preferred embodiments the polyvalent cation is Cadmium and Zone DS limits are between 0.2 to 2.2.

In preferred embodiments the metal products are selected from the group of the metal the oxides, hydroxides and the salts of the polyvalent cation.

Preferably the cation of the double salt is ammonium and the anion is sulfate.

While the invention will now be described in connection with certain preferred embodiments in the following examples so that aspects thereof may be more fully understood and appreciated, it is not intended to limit the invention to these particular embodiments. On the contrary, it is intended to cover all alternatives, modifications and equivalents as may be included within the scope of the invention as defined by the appended claims. Thus, the following examples which include preferred embodiments will serve to illustrate the practice of this invention, it being understood that the particulars shown are by way of example and for purposes of illustrative discussion of preferred embodiments of the present invention only and are presented in the cause of providing what is believed to be the most useful and readily understood description of formulation procedures as well as of the principles and conceptual aspects of the invention.

### EXAMPLES

### Comparative EXAMPLE 1

Various amounts of solutions obtained by leaching Ilmenite with sulfuric acid, various amounts of ammonia and of (NH₄)₂SO₄ were added into flasks. The flasks were shaken at 25° C. for 20 min or 1.5 hours. A precipitate was formed. The composition of the leachate Ilmenite solution is presented in Table 1 and the results in Tables 2.

TABLE 1

| Ti(SO₄)₂ | Fe₂(SO₄)₃ | FeSO₄ |
|---|---|---|
| Wt % | Wt % | Wt % |
| 11.0 | 2.0 | 8.17 |

TABLE 2
Results after 1.5 hours at RT

| | | (NH₄)₂SO₄ | Ti(SO₄)₂ in | Fe⁺³₂(SO₄)₃ | Fe⁺²SO₄ | Fe⁺²/Ti |
|---|---|---|---|---|---|---|
| | (NH₄)₂SO₄ | final | solution | In solution | In solution | In crystals |
| No. | Wt % | Wt % | Wt % | Wt % | Wt % | mole/mole |
| 1 | 24 | 9.59 | 1.3 | 2.5 | 2.76 | 0.88 |
| 2 | 21 | 6.01 | 2.2 | 2.3 | 4.80 | 0.60 |
| 3 | 17 | 4.73 | 3.7 | 2.6 | 7.92 | 0.05 |
| | 0 | 0.00 | 11.0 | 2.0 | 8.17 | — |

### Example 3

Various amount of solutions obtained by leaching Ilmenite with sulfuric acid, Ammonia and (NH4)₂SO₄ were added into flasks. The flasks were shaken at 25° C. for 1.5 hours. A precipitate was formed. The composition of the precipitate and solution is presented in Table 4.

TABLE 4

| | Initial | | Final (calculated for initial solution) | | | | Fe⁺²/Ti in |
|---|---|---|---|---|---|---|---|
| | Ti(SO₄)₂ | | (NH₄)₂SO₄ | | | | crystals |
| | in solution | (NH₄)₂SO₄ | final calculated | Ti | Fe₂(SO₄)₃ | FeSO₄ | calculated |
| No. | Wt % | Wt % | Wt % | Wt % | Wt % | Wt % | Mole/mole |
| | 20.5 | | | | | | |
| 7 | 20.5 | 23 | 16 | 1.5 | 3.8 | 1.7 | 0.41 |
| 8 | 20.5 | 19 | 12 | 2.7 | 4.0 | 5.8 | 0.09 |
| 9 | 20.5 | 13 | 7.3 | 9.0 | 4.3 | 7.0 | 0.00 |
| 10 | 20.5 | 16 | 8.8 | 3.9 | 3.9 | 6.7 | 0.02 |

### Example 4

Various amount of solutions obtained by leaching Ilmenite with sulfuric acid, and (NH4)₂SO₄ were added into flasks. The flasks were shaken at 30° C. for 20 min. A precipitate was formed. The composition of the initial solution is presented in Table 5 and that of the results in Table 6.

TABLE 5
Initial conditions

Concentration in leaching solutions

| | (NH₄)₂SO₄ | Ti(SO₄)₂ | Fe₂(SO₄)₃ | FeSO₄ |
|---|---|---|---|---|
| No. | Wt % | Wt % | Wt % | Wt % |
| 1 | 14.8 | 6.5 | 5.3 | 6.3 |
| 2 | 14.4 | 12.1 | 5.1 | 6.1 |
| 3 | 14.4 | 18.1 | 4.9 | 5.9 |

TABLE 6
Results

| | Ti(SO₄)₂ | | | |
|---|---|---|---|---|
| (NH₄)₂SO₄ in | In solution | Fe₂(SO₄)₃ | FeSO₄ | Fe⁺²/Ti in |
| solution (added) | Wt % | In solution | In solution | crystals |
| Wt % | wt % | Wt % | Wt % | mole/mole |
| 13 | 6.7 | 6.2 | 6.01 | 0.00 |
| 10 | 5.1 | 6.0 | 5.62 | 0.02 |

It will be evident to those skilled in the art that the invention is not limited to the details of the foregoing illustrative examples and that the present invention may be embodied in other specific forms without departing from the essential attributes thereof, and it is therefore desired that the present embodiments and examples be considered in all respects as illustrative and not restrictive, reference being made to the appended claims, rather than to the foregoing description, and all changes which come within the meaning and range of equivalency of the claims are therefore intended to be embraced therein.

What is claimed is:

1. A method for the Industrial purification of a low-grade polyvalent cation feed stream of purity P1, by the formation of a polyvalent cation-double-salt precipitate of purity P2 and a polyvalent cation solution with purity P3, wherein P2>P1>P3, said method comprising the steps of:
a) forming, from said feed, a medium comprising water, polyvalent cation, a cation selected from the group consisting of ammonium, cations of alkali metals, protons and a combination thereof, and anions; which formed medium is further characterized by the presence of (i) a double-salt precipitate comprising a polyvalent cation, at least one of said cations and at least one of said anions; and (ii) a polyvalent cation solution; and wherein the concentration of said anions is higher then 10% and the ratio between the concentrations of said cation to said anion in said polyvalent cation solution is within Zone DS as herein defined; and
b) separating at least a portion of said precipitate from said solution.

2. A method according to claim 1, further comprising the step of processing said precipitate to produce polyvalent metal oxide.

3. A method according to claim 1, further comprising the step of processing said precipitate to produce a polyvalent metal product other than metal oxide.

4. A method according to claim 1 wherein the process of said processing said precipitate includes a production stage of Mi metal.

5. A method according to claim 1, wherein said feed is an aqueous feed solution and said forming comprises contacting said feed solution with at least one of an acid, a base and a salt.

6. A method according to claim 1 wherein the polyvalent cation is selected from a group consisting of Ti(iv), Ti(iii), Fe(ii), Mn, Zn, Co, Cr, Al, Cd, Tin, Ni, V and Cd.

7. A method according to claim 1 wherein said polyvalent cation feed is formed by leaching ores of said polyvalent metals using an acid solution.

8. A method according to claim 1 wherein said polyvalent cation feed is formed by leaching ores of said polyvalent metals using a base solution.

9. A method according to claim 1, wherein P1 is in the range of between about 10% and about 90%.

10. A method according to claim 1, where P1 is less than 70% and P2 is greater than 95%.

11. A method according to claim 1, where P1 is less than 90% and P2 is greater than 98%.

12. A method according to claim 1 wherein said polyvalent cation feed stream comprises a waste stream from an industrial process.

13. A method according to claim 1, wherein the molar ratio between said polyvalent cation and other polyvalent cations in said double salt is greater than the ratio in said feed stream by a factor of at least 5.

14. A method according to claim 1 wherein said cation in said double-salt is ammonium.

15. A method according to claim 1 wherein said cation in said double-salt is selected from the group consisting of monoalkyl ammonium, dialkyl ammonium, trialkyl ammonium or tetraalkyl ammonium.

16. A method according to claim 1 wherein the cation in said double-salt is selected from the group consisting of sodium and potassium.

17. A method according to claim 1 wherein the anion in said double-salt is selected from the group consisting OH, SO₄ HSO₄ and halides.

18. A method according to claim 1 wherein the anion in said double-salt is selected from the group consisting organic acids.

19. A method according to claim 1 wherein said precipitate contains at least 80% of the polyvalent cation originally present in said low-grade-stream solution.

20. A method according to claim 1 wherein the ratio P2/P3 is greater than 2.

21. A method according to claim 1 wherein the ratio P2/P3 is greater than 10.

22. A method according to claim 1 wherein said polyvalent cation solution is modified to form products selected from the group consisting of products containing other polyvalent cations present in said titanium feed solution, wherein one of the modification stages is crystallization.

23. A method according to claim 22 wherein the products of the other polyvalent cations are selected from the group of double salts.

24. A method according to claim 1 further comprising the step of washing said separated precipitate to form washed precipitate with a purity of P4 and a wash solution with a purity of P5, wherein P4>P2>P5.

25. A method according to claim 24 wherein said washing is with a solution comprising at least one cation and at least one anion selected from said groups of claim 1, and wherein the concentration of said anion is higher then 10% and the ratio between the concentrations of said cation to said anion in said polyvalent cation solution is within Zone DS as hereinbefore defined.

26. A method according to claim 24 wherein said washing is with a solution comprising protons, said cation and sulfate ions.

27. A method according to claim 1 further comprising the step of re-crystallizing said precipitate, optionally pre-washed, to form a precipitate with a purity of P6 and a mother liquor with a purity of P7, wherein P6>P2>P7.

28. A method according to claim 27 wherein said re-crystallization uses a solution comprising at least one cation and at least one anion selected from said groups of claim 1.

29. A method according to claim 1, wherein said double salt is an iron double salt and the anion of said double iron salt is selected from the group consisting of monovalent anions, divalent anions, halide anions, sulfate and bisulfate anions, organic acids anions and a combination thereof.

30. A method according to claim 1 wherein the purity of said polyvalent cation-double-salt (P2) is greater than 80%.

31. A method according to claim 1 wherein the purity of said titanium-double-salt (P2) is greater than 99%.

32. A method according to claim 1 wherein said polyvalent cation feed is a mother liquor from the precipitation of a double salt.

33. A method according to claim 1 wherein the anion is SO₄ at a concentration higher then 20%.

34. A method according to claim 1 wherein the polyvalent cation is Zn(II) and the anion is SO₄ at a concentration higher then 28%.

35. A method according to claim 1, wherein said polyvalent cation product contains at least 70% of said polyvalent cation that was presented in said low-grade-stream solution.

36. A method according to claim 1 wherein the pH of said medium is lower then 5.

37. A method according to claim 1 wherein the polyvalent cation is Ti(iv) and Zone DS limits are between 0.3 to 1.35.

38. A method according to claim 1 wherein the polyvalent cation is Ti(iii) and Zone DS limits are between 0.8 to 1.65.

39. A method according to claim 1 wherein the polyvalent cation is Ti(ii) and Zone DS limits are between 1.5 to 3.5.

40. A method according to claim 1 wherein the polyvalent cation is Cu(ii) and Zone DS limits are between 0.3 to 1.0.

41. A method according to claim 1 wherein the polyvalent cation is Fe(iii) and Zone DS limits are between 0.5 to 3.

42. A method according to claim 1 wherein the polyvalent cation is Fe(ii) and Zone DS limits are between 0.8 to 4.

43. A method according to claim 1 wherein the polyvalent cation is Zn(ii) and Zone DS limits are between 0.25 to 1.75.

44. A method according to claim 1 wherein the polyvalent cation is manganese and Zone DS limits are between 0.6 to 1.2.

45. A method according to claim 1 wherein the polyvalent cation is cobalt and Zone DS limits are between 0.47 to 1.8.

46. A method according to claim 1 wherein the polyvalent cation is Chromium (Cr) and Zone DS limits are between 0.3 to 1.4.

47. A method according to claim 1 wherein the polyvalent cation is Al(ii) and Zone DS limits are between 0.5 to 1.2.

48. A method according to claim 1 wherein the polyvalent cation is Tin and Zone DS limits are between 0.8 to 2.5.

49. A method according to claim 1 wherein the polyvalent cation is Nickel and Zone DS limits are between 0.7 to 1.9.

50. A method according to claim 1 wherein the polyvalent cation is Vanadium and Zone DS limits are between 0.4 to 2.4.

51. A method according to claim 1 wherein the polyvalent cation is Cadmium and Zone DS limits are between 0.2 to 2.2.

52. A method according to claim 1 wherein the metal products are selected from the group of the metal the oxides, hydroxides and the salts of the polyvalent cation.

53. A method according to claims 37-51 wherein the cation of the double salt is ammonium and the anion is sulfate.
